(19) United States
(12) Patent Application Publication
(10) Pub. No.: US 2013/0260866 A1
(43) Pub. Date: Oct. 3, 2013

(54) GAME SYSTEM AND GAME CONTROL METHOD THEREFOR

(71) Applicants: Takashi INUBUSHI, Minato-ku (JP); Kenji KOBAYASHI, Minato-ku (JP); Daisuke KIDA, Minato-ku (JP); Takashi KAWANO, Minato-ku (JP); Tomoya INUDA, Minato-ku (JP); Tadashi MINAMINO, Minato-ku (JP)

(72) Inventors: Takashi INUBUSHI, Minato-ku (JP); Kenji KOBAYASHI, Minato-ku (JP); Daisuke KIDA, Minato-ku (JP); Takashi KAWANO, Minato-ku (JP); Tomoya INUDA, Minato-ku (JP); Tadashi MINAMINO, Minato-ku (JP)

(21) Appl. No.: 13/740,478

(22) Filed: Jan. 14, 2013

(30) Foreign Application Priority Data
Apr. 2, 2012 (JP) 2012-084379

(51) Int. Cl. G06F 13/00

(52) U.S. Cl. CPC G06F 13/00
USPC 463/24

(57) ABSTRACT

A game system comprises a first game control portion which makes a user of a game machine play a first game and a second game control portion which makes a user of a user terminal machine different from the game machine play a second game. The game control portion, where game play contents of the second game and identification information of the user are stored in a state of being correlated with each other, updates game data based on game play contents in the second game by the user each time the user plays the second game. The first game control portion obtains as reference data at least one portion of the game data when the user plays the first game, and generate effect in the first game depending on the reference data obtained.

### CROSS REFERENCE TO RELATED APPLICATION

This application claims priority to Japanese Patent Application No. 2012-084379, filed Apr. 2, 2012, the disclosure of which is hereby incorporated by reference in its entirety.

### TECHNICAL FIELD

The present invention relates to a game system capable of correlating a game which is played at a first game apparatus and a game which is played at a second game apparatus to each other.

### BACKGROUND ART

As a game system configured to maintain and improve motivation to game play by enhancing an interest of a user to a game, the user leaving a game machine, known is a game system where a game machine for commercial use and a terminal machine for personal use of a user are connected to a server apparatus and information correlated to a game of the game machine is provided to the terminal machine of the user as Web contents (e.g. Patent Literature 1).
Patent Literature 1: JP 2006-175004 A.

### SUMMARY OF INVENTION

### Technical Problem

However, in a conventional game system, a service to be provided at a terminal machine of a user is merely service circumstantial to a game which is provided at a main game machine. Accordingly, it is impossible to enhance interest of users who has never played a game and give users motivation to game play.

Then, the present invention aims to provide a game system capable of efficiently giving users a positive motivation to game play.

### Solution to Problem

A game system of the present invention is a game system comprising: a first game control device adapted and configured to allow a user of a first game apparatus to play a first game; and a second game control device adapted and configured to allow a user of a second game apparatus to play a second game regardless of whether or not a play history of the first game for the user exists, in which the second game control device is adapted and configured to update game data based on game play contents of the second game by the user each time the user plays the second game, the game data being stored in a state of being correlated with identification information of the user, and to, when the second game of next time is played by the user, allow the user to play the second game in succession to the last game play of the second game based on the game data corresponding to the identification information of the user, wherein the first game control device comprises: a reference data obtaining device adapted and configured to, when the user plays the first game, obtain as reference data at least one portion of the game data stored in a state of being correlated with the identification information of the user; and a reference effect control device adapted and configured to generate effect for the first game, the effect depending on the reference data obtained by the reference data obtaining device.

A game control method of the present invention is a game control method comprising: a first game control step of allowing a user of a first game apparatus to play a first game; and a second game control step of allowing a user of a second game apparatus to play a second game regardless of whether or not a play history of the first game for the user exists, in which the second game control step includes the steps of: updating game data based on game play contents of the second game by the user each time the user plays the second game, the game data being stored in a state of being correlated with identification information of the user; and when the second game of next time is played by the user, allowing the user to play the second game in succession to the last game play of the second game based on the game data corresponding to the identification information of the user, wherein the first game control step includes: a reference data obtaining step of, when the user plays the first game, obtaining as reference data at least one portion of the game data stored in a state of being correlated with the identification information of the user; and a reference effect control step of generating effect for the first game, the effect depending on the reference data obtained by the reference data obtaining step.

According to the present invention, the user can play the second game regardless of whether the play history of the first game exists or not, and each time the second game is played, the game data is updated by the second game control device. The updated game data is referred to, next time when the second game is played. Accordingly, the user can play the second game in succession to the last second game. Thereby, the user can play the second game continuously by the second game apparatus, separate from the first game. On the other hand, in the first game, at least one portion of the game data is obtained as the reference data, and it is possible to generate effect depending on the reference data. Accordingly, it is possible for the user to enjoy effect which is not obtained only by playing the first game, by reflecting the game play contents of the second game in the first game. Thereby, enjoyability of each game is enhanced, and synergistic effect due to a relation between the first and second games is generated. Accordingly, it is possible to give a positive motivation for game play to the user.

In one embodiment of the present invention, the first game control device may be adapted and configured to allow the user of the first game apparatus to play the first game even if the game data corresponding to the user does not exist. According to this embodiment, the user can select to play only the first game or only the second game. That is, it is possible to provide versatile selections appropriately to a user's taste with respect to game play.

The first game control device may be adapted and configured to be incapable of updating the game data. According to this embodiment, it is possible to give a relation between the first game and the second game while it is avoided that such unfavorable case that the game data is updated due to playing the first game without intention occurs.

In one embodiment of the present invention, each of the first game apparatus and the second game apparatus may be capable of connecting to a server apparatus via a network, the game data updated by the second game control device may be stored in the server apparatus in a state of being correlated with the identification information of the user, and the reference data obtaining device may be adapted and configured to obtain as the reference data at least one portion of the game data stored in the server apparatus in a state of being correlated with the identification information of the user of the first game apparatus. According to this embodiment, by storing the game data in the server apparatus, it is possible to make the first game control device obtain the reference data and refer to the reference data easily at the moment of playing the first game.

In one embodiment of the present invention, the first game control device may be adapted and configured to calculate a result of the first game based on operations by the user in the first game; and the reference effect control device may be adapted and configured to change the result of the first game depending on the reference data obtained by the reference data obtaining device. According to this embodiment, the result of the first game which is calculated in response to operations by the user in the first game changes depending on the reference data. Thereby, it is possible to reflect the game play contents of the second game in the first game and give a relation between the first game and the second game.

Moreover, the first game control device may be adapted and configured to move a play character set as an operation object of the user in response to operations by the user, and calculate the result of the first game based on actions of the player character, the second game control device may be adapted and configured to bring up a bringing up character set as a bringing up object of the user in response to operations by the user, and store information depending on a result of bringing up the bringing up character, the reference data obtaining device may be adapted and configured to obtain the information of the result of bringing up as the reference data, and the reference effect control device may be adapted and configured to make the bringing up character appear in the first game, and change the result of the first game based on the reference data while controlling actions of the bringing up character based on the reference data. According to this embodiment, while bringing up the bringing up character in the second game, the user can make the character brought up appear in the first game, and can enjoy the effect of brining up in the first game.

### Effects of Invention

As mentioned above, according to the present invention, a user can play the second game continuously by the second game apparatus, separating from the first game. On the other hand, as the game play contents of the second game is reflected in the first game, the user can enjoy the effect which is not obtained only by playing the first game. Thereby, enjoyability of each game is enhanced, and synergistic effect due to a relation between the first and second games is generated. Accordingly, it is possible to give a positive motivation for game play to the user.

### BRIEF DESCRIPTION OF DRAWINGS

FIG. 1 is a diagram showing a whole configuration of a game system according to one embodiment of the present invention

FIG. 2 is a function block diagram for an essential portion of the game system

FIG. 3 is a diagram showing a concept of one example of a game implemented in the game system

FIG. 4 is a diagram showing one example of a construction of the play data which is generated in a state of correlating with the game shown in FIG. 3

FIG. 5 is a flow chart showing procedures implemented by the user terminal machine to allow the user to play the mobile game

FIG. 6 is a flow chart showing procedures implemented by the game machine to allow the user to play the arcade game

### DESCRIPTION OF EMBODIMENT

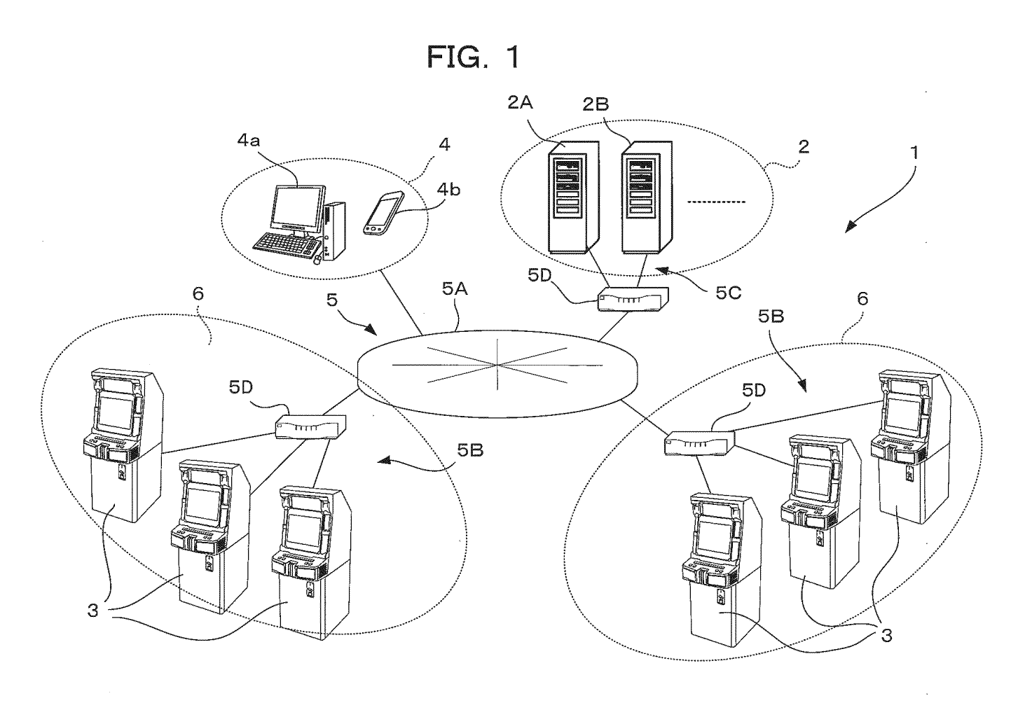

Hereinafter, a game system as one embodiment according to the present invention will be described. First, in reference to FIG. 1, a whole configuration of the game system will be described. The game system 1 includes a center server 2 as a server apparatus, and a game machine 3 and a user terminal machine 4 as client machines capable of connecting to the center server 2 via a predetermined network 5. The center server 2 is configured as one logical server by combining plural servers 2A, 2B . . . . However, the center server 2 may be configured by one unit of server. Alternatively, the center server 2 may be logically configured by using the cloud computing.

The game machine 3 is configured as a game machine for commercial use (business use) which allows, in exchange of payment of a predetermined game play fee, a user to play a game within a range corresponding to the game play fee. This kind of game machine 3 is sometimes called an arcade game machine. In the description hereinafter, the arcade game machine 3 is referred to as the game machine 3. The arcade game machine 3 is a computer game machine which is installed to a predetermined facility such as a shop 6, having a main aim to obtain benefit by making a lot of players play the game, and the arcade game machine 3 has game environments suite to the aim. For example, the game machine 3 has: a chassis having a shape and decorations for representing a game world; an input device suit to game operations; a display device for displaying game pictures at high resolution; and a high-end control system (hardware and software) for implementing a high-end game. To a shop, one arcade game machine 3 or the appropriate number of arcade game machines 3 is/are installed. In FIG. 1, though the arcade game machines 3 are represented so as not to be discriminated, the hardware configuration and game contents each of them may be selected felicitously. The arcade game machine 3 may be configured as a dedicated machine which has a specialized configuration (e.g. operation portion) applied to a particular game, or may be configured as a versatile machine applicable to various kinds of games by rewriting software. In the game system 1, the arcade game machine 3 corresponds to the first game apparatus of the present invention, and the game played at the arcade game machine 3 corresponds to the first game.

On the other hand, the user terminal machine 4 is a computer machine which is capable of connecting to a network and is used for a personal use of a user. For example, a stationary or book-type personal computer (hereinafter, referred to as the “PC”) 4a, or a mobile terminal machine 4b such as a mobile phone (including a smart phone) is used as the user terminal machine 4. Besides, various kinds of computer machines which are capable of connecting with a network and used for personal use of the user like a stationary game machine for home use, a mobile-type game machine, and a mobile-type tablet terminal machine, may be used as the user terminal machines 4.

The user terminal machine 4 can provide various kinds of functions to a user by mounting various kinds of software. In the present embodiment, the user terminal machine 4 can function as the second game apparatus which allows a user to play the second game, by mounting a predetermined game application program. The game environments of the user terminal machine 4 are different from those of the arcade game machine 3. That is, the user terminal machine 4 has generally a limitation with respect to hardware ability such as a CPU processing ability, a display size, and a display resolution, in comparison with the arcade game machine 3. Particularly, in a case that the user terminal machine 4 is a mobile device like the mobile terminal machine 4b, the limitation is comparatively big. In this case, the game played at the user terminal machine 4 is set as a game a user can play carefreely, unlike a game played at the arcade game machine 3. Hereinafter, explanation is continued based on a case example that the user terminal machine 4 is a mobile machine. By referring to a game played at the arcade game machine 3 and a game played at the user terminal machine 4 as an arcade game and a mobile game respectively, the games are sometimes discriminated.

With respect to a server-client system, as a system for making a user play a game at a mobile machine as a client apparatus, there are various utilization forms of a server, such as: a system that software necessary for calculation control of the game is installed in the client apparatus, and the client apparatus accesses the server only in minimum cases that processing by the server is required; and a system that installed in the client apparatus is only software for realizing an interface function such as input of operation information of a user, and output of a game picture and a music piece, and by implementing the software, the client apparatus is connected with the server at the moment of implementing the game, and calculation processing for the game is implemented at a server side. In the present embodiment, explanation is continued based on an example case that the calculation processing for the game based on the operation information of the user is implemented at the arcade game machine 3 and the user terminal machine 4.

It does not matter which network is applied to the network 5, as long as the network can connect the arcade game machine 3 and the user terminal machine 4 independently with the center server 2. As one example, the network 5 is configured so as to realize a network communication by using the TCP/IP protocol. Typically, the network 5 is configured by connecting via a router 5D, the internet 5A as a WAN with LANs 5B, 5C, the LANs 5B, 5C connecting the center server 2 and the arcade game machine 3 with the internet 5A respectively. The user terminal machine 4 is also felicitously configured to be connected with the internet 4A. In addition, a local server may be installed between the game machine 3 and the router 5D in the shop 6, and the game machine 3 can connect and communicate with the center server 2 via the local server. The servers 2A, 2B . . . of the center server 2 may be connected to each other by the WAN 5A in place of, or in addition to, the LAN 5C.

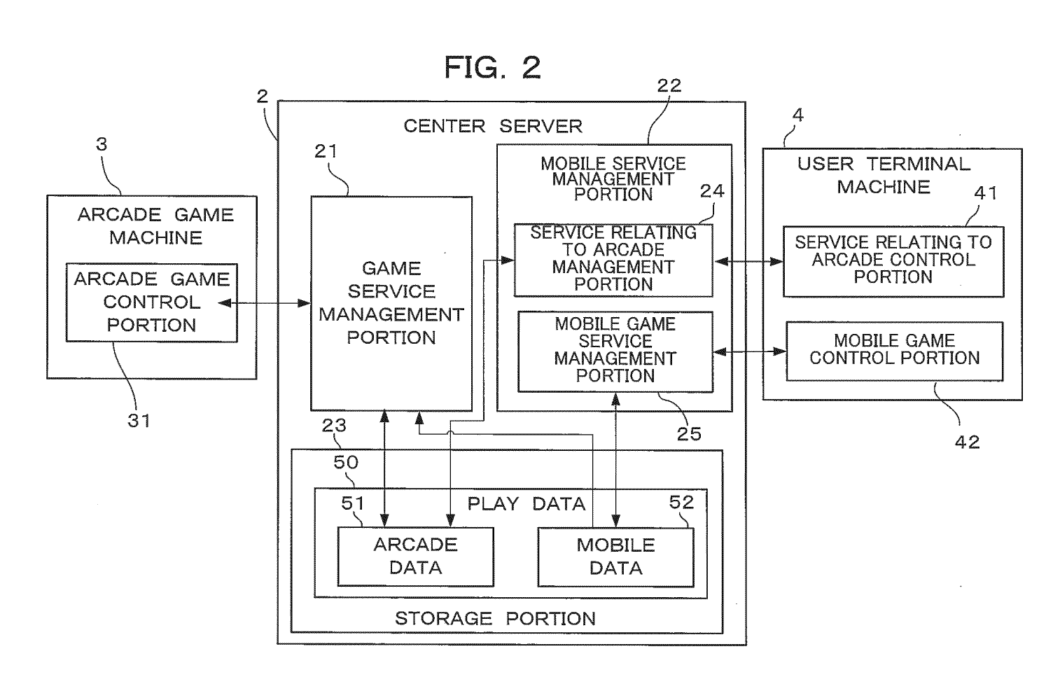

Next, in reference to FIG. 2, a system relating to games of the center server 2, the arcade game machine 3, and the user terminal machine 4 in the game system 1 will be described. The center server 2 comprises a game service management portion 21, a mobile service management portion 22, and a storage portion 23. Each of the management portions 21, 22 is a logical device to be realized by combining computer software and computer hardware of the center server 2. The computer hardware includes a CPU and a memory as internal storage necessary for operations of the CPU. The storage portion 23 is a external storage which is realized by a memory unit such as a hard disk allay. The storage portion 23 may be configured so that one memory unit contains all data, or may be configured so that plural memory units contain data decentrally. Although various kinds of data are stored in the storage portion 23, FIG. 2 shows only play data 50. The play data 50 is data having game play contents for a user to resume further game play. The play data 50 includes arcade data 51 for the arcade game and mobile data 52 for the mobile game. The play data 50 is generated for each user, and correlated to identification information of the user to be stored in the storage portion 23. The concrete example of the play data 50 will be described later.

The game service management portion 21 provides predetermined game service to the arcade game machine 3. The game service includes the following services: for example, a service that a user is verified by receiving verification information (e.g. identification information and a password which are unique to each user) from the game machine 3, and arcade data 51 is received from the game machine 3 and stored in the storage portion 23, or the arcade data 51 and the mobile data 52 of the user stored in the storage portion 23 are provided to the game machine 3; a service that software (a program for a game or data) for an arcade game installed in the game machine 3 is updated via a network; and a service that users are coupled with each other when the users play one common arcade game via the network 5.

The mobile game service management portion 22 provides various kinds of mobile services to the user terminal machine 4. Especially, as a logical device for providing services relating to a game of those services, a service relating to arcade management portion 24 and a mobile game service management portion 25 are further provided in the mobile service management portion 22. The service relating to arcade management portion 24 verifies a user by receiving verification information of the user (e.g. identification information and a password which are unique to each user) from the user terminal machine 4, and in response to a requirement by the user verified, information in the arcade data 51 included in the play data 50 of the user is provided to the user terminal machine 4.

On the other hand, the mobile game service management portion 25 verifies a user of the user terminal machine 4, and provides to the user verified, service necessary for enable the user to play the mobile game at the user terminal machine 4. The service includes the following services: for example, a service that mobile data 52 of the mobile game played at the user terminal machine 4 is received from the user terminal machine 4 and stored in the storage portion 23, or the mobile data 52 of the user stored in the storage portion 23 is provided to the user terminal machine 4; a service that software (a program for a game or data) for a mobile game installed in the user terminal machine 4 is updated via the network 5; and a service that users are coupled with each other for the users to play one common mobile game via the network 5.

The center server 2 is also provided with a charge service function to charge, on users of the arcade game machine 3 and the user terminal machine 4 respectively, a fee as compensation for providing paid service in a game and collect the fee from the user. A concrete method of settlement may be a method such that the compensation of service is charged on a user and a fee according to the compensation is collected by using electronic settlement where a fee can be paid using exchange of electronic information, such as a credit card, a debit card, or electronic money. The electronic settlement may be already-known one, and the explanation of the concrete configuration and the procedures for realizing the electronic settlement is omitted. Further, the center server 2 may be appropriately provided with a logical device which implements various kinds of services such as a community service providing a communication place enabling information transmission, information exchanging, information sharing using the user terminal machines 4. The explanations of the services are omitted.

Next, the arcade game machine 3 is provided with an arcade game control portion 31 as a logical device which is realized by combining computer hardware (a CPU and a memory as an internal storage thereof are included) and computer software. The arcade game control portion 31 implements various kinds of operations necessary for getting the game service which is provided by the game service management portion 21 of the center server 2, while implementing various kinds of calculation control necessary for progressing the arcade game. The user terminal machine 4 is provided with a service relating to arcade control portion 41 and a mobile game control portion 42, as the logical devices which are realized by combining computer hardware (a CPU and a memory as an internal storage are included) and computer software of the user terminal machine 4. The service relating to arcade control portion 41 requires the service relating to arcade management portion 24 of the center server 2 to provide information of the arcade data 51, and allows the user to view the information transmitted from the service relating to arcade management portion 24. The mobile game control portion 42 implements various kinds of operations necessary for getting the game service which is provided by the mobile game service management portion 25 of the center server 2, while implementing various kinds of calculation control necessary for progressing the mobile game. Each of the arcade game machine 3 and the user terminal machine 4 is provided with an external storage which stores programs and data for the game. The external storage is not illustrated.

In the game system 1, with respect to the identification information of a user to be used for the user verification, it does not matter which the identification information is common or different between the user verification of the arcade game machine 3 and the user verification of the user terminal machine 4. In a case of common, in a state of associating the play data 50 of a user with identification information (e.g. a user ID) of the user to be used for the user verification, the arcade data 51 and the mobile data 52 of the play data 50 may be stored in the storage portion 23. On the other hand, in a case of different, that is, in a case that the identification information of the user which the user should input to the arcade game machine 3 is different from the identification information of the user which the user input to the user terminal machine 4, the two kinds of identification information are correlated with each other. Thereby, whichever place the user accesses from the arcade game machine 3 or the user terminal machine 4, both of the arcade data 51 and the mobile data 52 of the user can be specified. As the identification information of the user being used here, it is sufficient if the information can become a clue for specifying the arcade data 51 and the mobile data 52 of the play data 50 respectively. For example, at the arcade game machine 3, even if a unique ID for each medium is recorded as identification information in a medium (e.g. a card or an IC chip) held by a user, and the ID of the medium and the arcade data 51 are correlated with each other and stored in the storage portion 23, the ID of the medium corresponds to the identification information of the user substantially. While the ID of the medium is used as the identification information of the user at the arcade game machine 3, a unique ID for each user set arbitrarily by the user can be used as the identification information of the user at the user terminal machine 4, and the ID of the user and the mobile data 52 can be correlated with each other, by correlating the ID of the medium with the ID of the user. Even in this case, whichever ID is used as the identification information of the user, it is possible to specify the arcade data 51 and the mobile data 52 of the user to refer to both data at either the arcade game machine 3 or the user terminal machine 4. Hereinafter, the user identification information to be used for the user verification of the arcade game machine 3 is sometimes called “the arcade ID”, and the user identification information to be used for the user verification of the user terminal machine 4 is sometimes called “the mobile ID” in order to discriminate between the IDs.

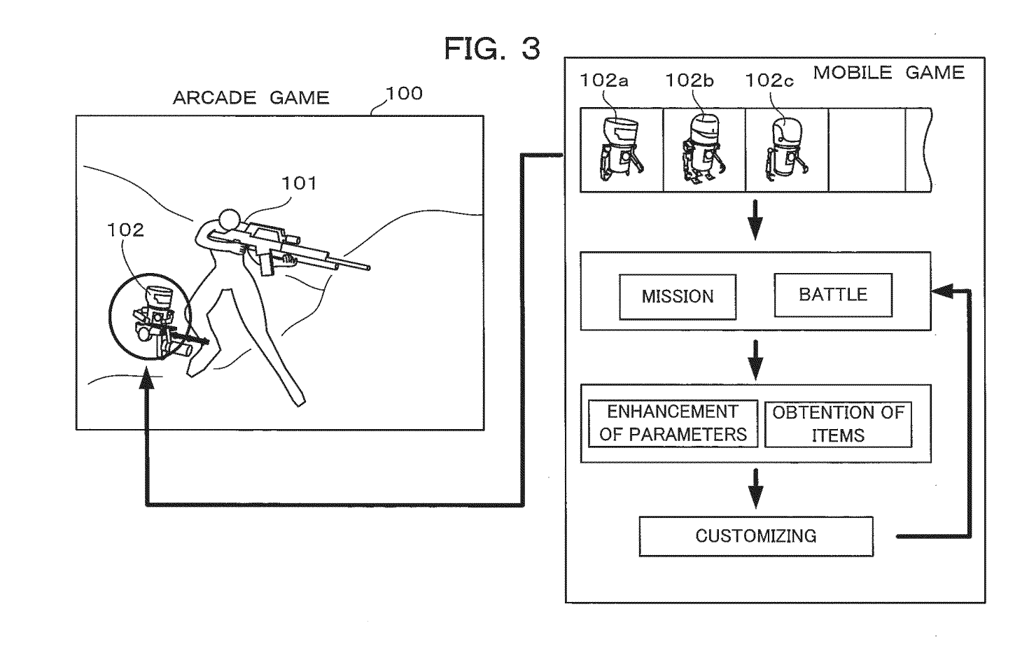

Next, described will be a specific example of a game implemented in the game system 1. FIG. 3 shows a relation between games which are implemented at the arcade game machine 3 and the user terminal machine 4 respectively. As the arcade game, implemented is a game where a play character 101 which is displayed in a game picture 100 where a virtual game world is represented is controlled by a user to accomplish a predetermined mission or to battle against an enemy. As shown as a circle sign in the game picture 100 in FIG. 3, a sub-character 102 is also displayed in the game picture 100 in accordance with a predetermined condition. The sub-character 102 is set as a character which acts accompanying the player character 101, and it is impossible for a user to directly control the action of the sub-character. When the action of the player character 101 is determined based on operations by a user, depending on the action, the action of the sub-character 102 is automatically determined. The actions of the sub-character 102 are set as such actions, for example, supporting the player character 101, and helping the player character 101.

On the other hand, as the mobile game, a game for bringing up the sub-character 102 is implemented. In the mobile game, a user selects the sub-character 102 as a target to be brought up from a plurality of sub-characters 102a-102c which are prepared in advance as candidates for a sub-character to be brought up, and the user plays missions and battles prepared in the mobile game by using the selected sub-character 102 in order to bring up the selected sub-character 102. As the bringing-up effects, various kinds of parameters which characterize the sub-character 102, for example, a stamina value, a force value, and a defense value are enhanced, or items which the sub-character 102 can carry are increased. Further, the user can customize the sub-character 102 using the items. By repeating such procedures, the sub-character is brought up gradually. The parameters and the carrying items of the sub-character 102 affect not only the proceedings of the mobile game, but also the proceedings of the arcade game. For example, the more enhanced are the parameters of the character 102, the more the ability of the sub-character 102 in the arcade game is enhanced, or action selection of the sub-character 102 in the arcade game changes depending on the carrying items of the sub-character 102. In addition, the number of the sub-characters 102 which the user can bring up may be increased gradually depending on the play state of the mobile game.

It is possible to play the arcade game without the sub-character 102. Even if the sub-character 102 is used in the arcade game, the parameters and the carrying items do not change. That is, in the arcade game, the sub-character 102 which has been brought up in the mobile game is only available, there are no elements for binging up the sub-character 102 in the arcade game. On the other hand, it is possible to play the mobile game for the purpose of bringing up the sub-character 102 itself. The user can play only the mobile game even if not playing the arcade game.

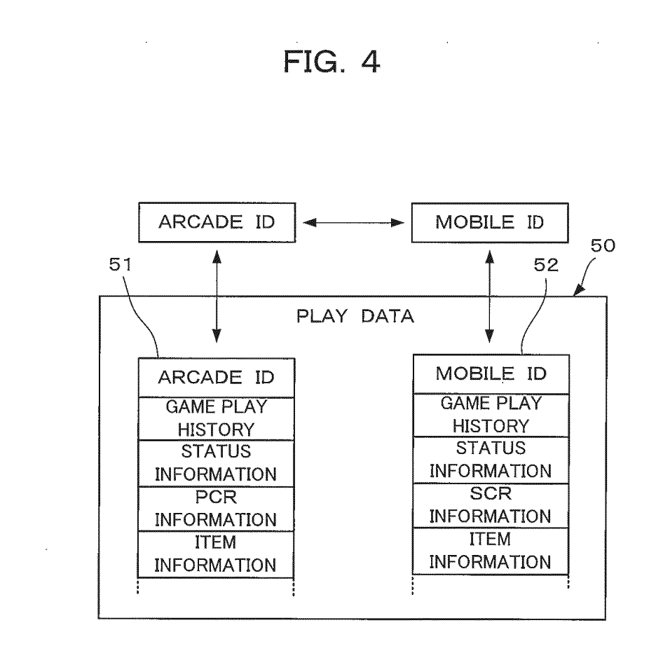

FIG. 4 shows a specific example of play data 50 for the arcade game and the mobile game. In the example of FIG. 4, the arcade data 51 is stored in a state of being correlated with the arcade ID, and the mobile data 52 is stored in a state of being correlated with the mobile ID. The arcade data 51 includes information of game play history (game play date, game play times, game play hours, game play contents and so on) in the arcade game of the user, information of status which the user obtains by playing the arcade game (status information), information of the parameters of the player character 101 (PCR information), information of items which the player character 101 can use (item information) and so on. The information relating to the mobile game such as the information of the sub-character 102 is not included in the arcade data 51. On the other hand, the mobile data 52 includes information of game play history (game play date, game play times, game play hours, game play contents and so on) in the mobile game, information of status which the user obtains by playing the mobile game (status information), information of the parameters of the sub-character 102 (SCR information), information of items which the sub-character 102 can use (item information) and so on. That is, the mobile data 52 corresponds to the game data relating to the second game of the present invention. The information relating to the arcade game such as the information of the player character 101 is not included in the mobile data 52. That is, the arcade data 51 is data which is generated uniquely and updated in the arcade game, and the mobile data 52 is data which is generated uniquely and updated in the mobile game. Each of the data 51, 52 exists independently of each other. As mentioned above, it is possible to set a correlation between the IDs. When the correlation exists, whichever ID is used, it is possible to specify the arcade data 51 and the mobile data 52 unambiguously. However, in a case that the both kinds of data 51,52 are stored in a state of being correlated with any one ID of the arcade ID and the mobile ID, and each data 51,52 is specified by using the other ID, the following construction may be applied. The play data 50 may be configured so that each data 51,52 is specified by determining the one ID corresponding to the other ID.

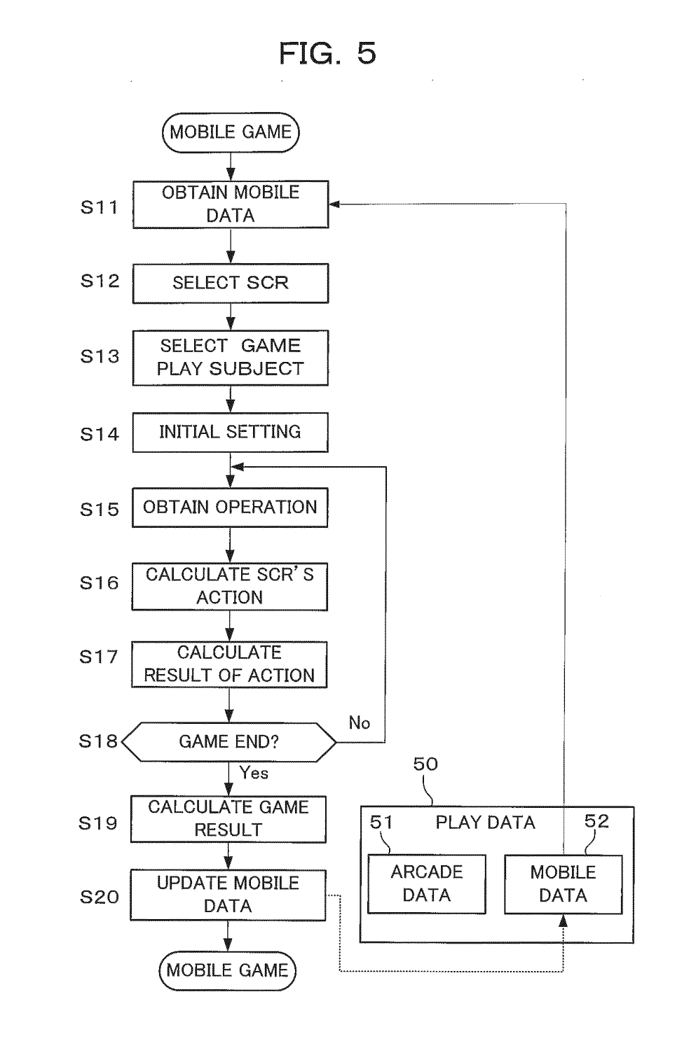

Next, the processes implemented by the game system 1 in order to allow a user to play the arcade game and the mobile game will be described. The following any process is implemented after the user verification is completed. FIG. 5 shows processes to be implemented for executing the mobile game at the user terminal machine 4. This processes are implemented by the mobile game control portion 42 (hereinafter, sometimes referred to as “the game control portion 42) of the user terminal machine 4. First, when a user of the user terminal machine 4 orders a start of the mobile game, the game control portion 42 obtains the mobile data 52 of the user (step S11). At this moment, in a case that the mobile data 52 is stored in the user terminal machine 4, the mobile data 52 is obtained. In a case that the mobile data 52 is not stored in the user terminal machine 4, the mobile data 52 of the user is obtained via the mobile game service management portion 25 of the center server 2.

Subsequently, the game control portion 42 allows the user to select one sub-character 102 as a target to be brought up from the sub-characters (referred to as “SCR” in drawings) 102 stored in the mobile data 52. Next, the game control portion 42 allows the user to select a game play subject, that is, a mission or a battle which the user is going to play (step S13), and sets an initial setting necessary for implementing the game play subject selected by the user (step S14). After that, the game control portion 42 starts the game play subject selected by the user, and obtains operations by the user (step S15). Subsequently, the game control portion 42 calculates actions of the sub-character 102 in the mobile game based on operations by the user (step S16). Further, calculated is the result of actions of the sub-character 102, that is, the effects given to the game progress by the actions of the sub-character 102.

After calculating the effects, the game control portion 42 determines whether a condition of game end is satisfied or not (step S18). In a case the condition is not satisfied, the game control portion 42 returns to step S15. In a case that it is determined that the condition of game end is satisfied at step S18, the game control unit 42 calculates the game result (step S19). In this case, the game control portion 42 calculates various kinds of information to be recorded in the mobile data 52, such as a value of parameter of the sub-character 102 in which the result of this time game is reflected, presence or absence of equipping items newly obtained, a status of the user in the mobile game. Subsequently, the game control portion 42 updates the mobile game data 52 so that the result of this time game is reflected in the mobile game data 52, and stores the mobile data 52 updated in the storage portion 23 via the mobile game service management portion 25 of the center server 2 (step S20). In this way, in the mobile game, implemented is a game where the sub-character 102 is brought up based on the mobile data 52 stored in the storage portion 23 of the center server 2, and the mobile data 52 in the storage portion 23 is updated in such a way that the result of the game (enhanced parameters, equipping items and so on) is reflected in the mobile data 52. The arcade data 51 is never updated in the mobile game. Further, in the mobile game, the arcade data 51 is not referred to. Accordingly, even if a user does not play the arcade game, he/she can play the mobile game. Also, playing the arcade game is never required to progress the mobile game. In addition, playing the arcade game does not affect playing the mobile game advantageously.

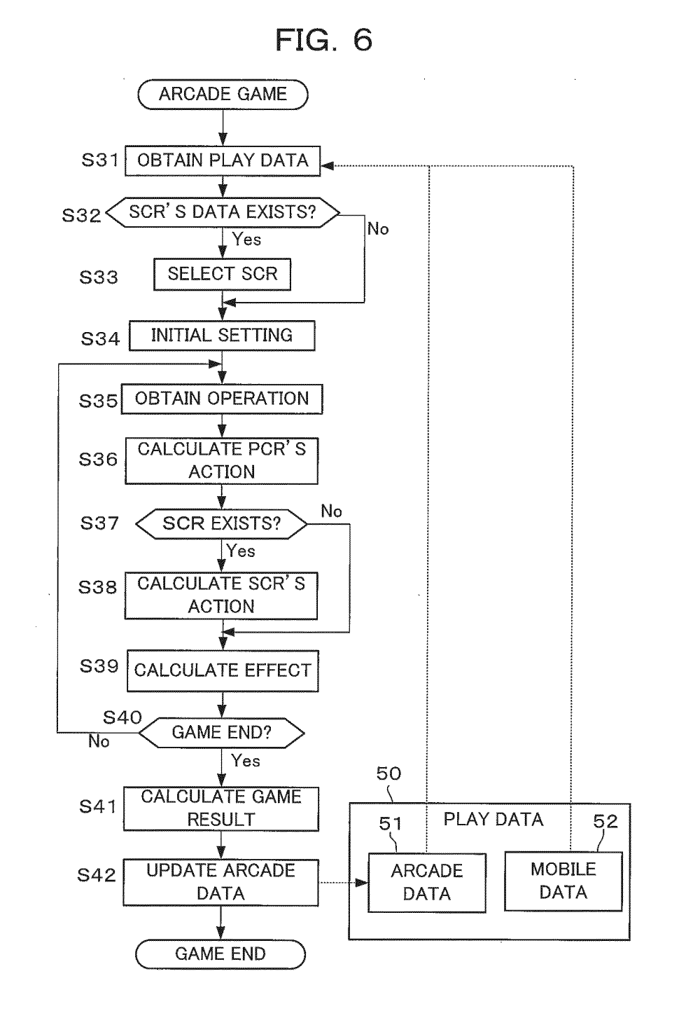

FIG. 6 shows proceedings for implementing the arcade game at the arcade game machine 3. These proceedings are implemented by the game control portion 31 of the arcade game machine 3 (hereinafter, sometimes referred to as only “the game control portion 31”). First, when a user of the arcade game machine 3 indicates a start of the arcade game, the game control portion 31 obtains the play data 50 of the user via the game service management portion 21 of the center server 2 (step S31), and determines whether or not data of the sub-character 102 (or the mobile data 52) exists as reference data in the play data 50 (step S32). In step S31, the game control portion 31 may obtain as the reference data, only SCR information and item information with respect to the mobile data 52. In a case that the data of the sub-character 102 exists, the game control portion 31 allows the user to select a sub-character 102 to be used in the arcade game and stores the result of selection (step S33). After that, the game control portion 31 progresses to an initial setting of step S34 which is necessary for starting the arcade game in accordance with the selection by the user and the like. In a case that it is determined that the data of sub-character 102 does not exist at step S32, the game control portion 31 skips step S33 to progress to step S34.

In step S34, the game control portion 31 allows the user to select a game play subject (e.g. a mission), and implements an initial setting necessary for allowing the user to play the arcade game depending on the game play subject selected. After that, the game control portion 31 starts the game play subject selected by the user and obtains operations by the user (step S35). Subsequently, the game control unit 31 calculates action of the player character 101 in the arcade game based on operations by the user (step S36). Next, the game control portion 31 determines whether or not the sub-character 102 exists in this game (step S37). In a case that the sub-character 102 exists, the game control portion 31 calculates an action of the sub-character 102 based on the action of the player character 101 calculated in step S36 (step S38). In a case that the sub-character 102 does not exist, the proceedings of step S38 is skipped.

After that, the game control portion 31 calculates the effect given to the game by this time action of the character (step S39). In this case, in a case that the sub-character 102 does not exist, only effect given by the action of the player character 101 is calculated based on information such as the parameters and the equipping items of the player character 101 which are stored in the arcade data 51. In a case that the sub-character 102 exits, as well as effect given by the action of the player character 101, effect given by the action of the sub-character 102 is also calculated based on information such as the parameters and the equipping items of the sub-character 102 which are stored in the mobile data 52. Accordingly, the calculation result in step S39 is different depending on whether the sub-character 102 exists or not even if the operations by the user is the same between the cases. In addition, even if the sub-character 102 exits, the calculation result is different depending on the parameters of ability and the equipping items of the sub-character 102.

After calculating the effect, the game control portion 31 determines whether or not a game end condition is satisfied (step S40). In a case of not satisfied, the game control portion returns to the step S35 (step s41). In this case, the game control portion 31 calculates various kinds of information to be stored in the arcade data 51, like the value of parameters of the player character 101, in which this time game result is reflected, presence or absence of equipping item newly obtained, and a status of user in the arcade game. Subsequently, the game control portion 31 updates the arcade data 51 so that this time game result is reflected in the arcade data 51, and stores in the storage portion 23, the arcade data 51 updated via the game service management portion 21 of the center server 2 (step S42).

In this way, in the arcade game, the game progress is controlled based on the arcade data 51 and the mobile data 52 stored in the storage portion 23 of the center server 2. Although the game result (such as enhancement of parameters and obtention of equipping items with respect to the player character 101) is reflected in only the arcade data 51, the mobile data 52 is never updated by the result of the arcade game. When the arcade game is played, if the sub-character 102 does not exist, negative determination is just obtained at step S32 and step 37, and it is possible to play the arcade game. Accordingly, even if the user does not play the mobile game, he/she can play the arcade game. However, it is possible for the sub-character 102 to join in the arcade game based on the mobile data 52. In this case, the result of the arcade game is changed depending on the ability of the sub-character 102. In this way, the mobile game is associated with the arcade game. Thereby, it is possible to give a motivation of playing both of the mobile game and the arcade tame to the user.

In the above mentioned embodiment, the arcade game control portion 31 functions as the first game control device of the present invention by implementing the proceedings of steps S31 to S42 in FIG. 6. the mobile game control portion 42 functions as the second game control device of the present invention by implementing the proceedings of steps S11 to S20 in FIG. 5. The arcade game control portion 31 functions as the reference data obtaining device by implementing the proceeding of step S31 in FIG. 6, and functions as the reference effect control device by implementing the proceedings of steps S38 and S39 in FIG. 6.

The present invention is not limited to the above embodiment, but can be executed in other felicitous embodiments. For example, in the above embodiment, in a server client type game system, both of the first game control device and the second game control device exist in the game machine and the user terminal machine as the client machine. At least one of the game control devices may be provided in the server apparatus. For example, the following embodiment is available. The center server 2 is made to implement the proceedings shown in FIG. 5, the proceedings relating to the mobile game in response to requests from the user terminal machine 4, and the user terminal machine 4 is made to function as the input device for operation information necessary for calculation control and the output device for a game picture and the like obtained by a calculation result. In this case, the center server 2 functions as the second game control device. The first game control device can be changed in a similar way. That is, it is possible to realize the first game control device and the second game control device of the present invention by felicitous computers included in the server client type game system.

In the present embodiment, the first game and the second game are not limited to the above embodiment, and may be selected felicitously. The relation between the first and the second games may be set appropriately as long as at least one portion of game data to be updated at an appropriate timing due to the fact that the user played the second game is referred to as the reference data by the first game control device, and the effect based on the reference data is made to occur in the first game. The first game control device is not limited to such a configuration that the game control device allows the user to resume the first game in succession to the last game play, referring to game data for each user which is updated depending on the game play contents of the first game like the arcade data 51. The first game control device may allow the user to play the first game in various embodiments, as long as, even if the game data corresponding to the first game is not used, the effect corresponding to at least one portion of game data relating to the second game is made to occur in the first game. Also, the effect based on the reference data is not limited to a case which affects the game result of the first game like the action of the sub-character 102. For example, in a case that some performance by special image and music is provided in the first game based on the reference data, even if the reference data does not affect a game result of the first game, the performance is included in an effect range caused by the reference data. The first game apparatus and the second game apparatus are possible to be appropriately changed. For example, it is possible to execute the present invention in such a way that the first game apparatus is changed to the user terminal machine 4 and the second game apparatus is changed to the game machine 3. It is also possible that the first game apparatus is changed to a stationary game machine for home use and the second game apparatus changed to a mobile type game machine. In addition, it is possible to select various kinds of game apparatus as the first game apparatus and the second game apparatus respectively.

What is claimed is:

1. A game system comprising:
a first game control device adapted and configured to allow a user of a first game apparatus to play a first game; and
a second game control device adapted and configured to allow a user of a second game apparatus to play a second game regardless of whether or not a play history of the first game for the user exists,
in which the second game control device is adapted and configured to update game data based on game play contents of the second game by the user each time the user plays the second game, the game data being stored in a state of being correlated with identification information of the user, and to, when the second game of next time is played by the user, allow the user to play the second game in succession to the last game play of the second game based on the game data corresponding to the identification information of the user, wherein
the first game control device comprises:
a reference data obtaining device adapted and configured to, when the user plays the first game, obtain as reference data at least one portion of the game data stored in a state of being correlated with the identification information of the user; and
a reference effect control device adapted and configured to generate effect for the first game, the effect depending on the reference data obtained by the reference data obtaining device.

2. The game system according to claim 1, wherein
the first game control device is adapted and configured to allow the user of the first game apparatus to play the first game even if the game data corresponding to the user does not exist.

3. The game system according to claim 1, wherein
the first game control device is adapted and configured to be incapable of updating the game data.

4. The game system according to claim 1, wherein
each of the first game apparatus and the second game apparatus is capable of connecting to a server apparatus via a network,
the game data updated by the second game control device is stored in the server apparatus in a state of being correlated with the identification information of the user, and
the reference data obtaining device is adapted and configured to obtain as the reference data at least one portion of the game data stored in the server apparatus in a state of being correlated with the identification information of the user of the first game apparatus.

5. The game system according to claim 1, wherein
the first game control device is adapted and configured to calculate a result of the first game based on operations by the user in the first game; and
the reference effect control device is adapted and configured to change the result of the first game depending on the reference data obtained by the reference data obtaining device.

6. The game system according to claim 5, wherein
the first game control device is adapted and configured to move a play character set as an operation object of the user in response to operations by the user, and calculate the result of the first game based on actions of the player character,
the second game control device is adapted and configured to bring up a bringing up character set as a bringing up object of the user in response to operations by the user, and store information depending on a result of bringing up the bringing up character,
the reference data obtaining device is adapted and configured to obtain the information of the result of bringing up as the reference data, and
the reference effect control device is adapted and configured to make the bringing up character appear in the first game, and change the result of the first game based on the reference data while controlling actions of the bringing up character based on the reference data.

7. A game control method comprising: a first game control step of allowing a user of a first game apparatus to play a first game; and a second game control step of allowing a user of a second game apparatus to play a second game regardless of whether or not a play history of the first game for the user exists, in which the second game control step includes the steps of: updating game data based on game play contents of the second game by the user each time the user plays the second game, the game data being stored in a state of being correlated with identification information of the user; and when the second game of next time is played by the user, allowing the user to play the second game in succession to the last game play of the second game based on the game data corresponding to the identification information of the user, wherein
the first game control step includes:
a reference data obtaining step of, when the user plays the first game, obtaining as reference data at least one portion of the game data stored in a state of being correlated with the identification information of the user; and
a reference effect control step of generating effect for the first game, the effect depending on the reference data obtained by the reference data obtaining step.

8. The game system according to claim 2, wherein
the first game control device is adapted and configured to be incapable of updating the game data.

9. The game system according to claim 2, wherein
each of the first game apparatus and the second game apparatus is capable of connecting to a server apparatus via a network,
the game data updated by the second game control device is stored in the server apparatus in a state of being correlated with the identification information of the user, and
the reference data obtaining device is adapted and configured to obtain as the reference data at least one portion of the game data stored in the server apparatus in a state of being correlated with the identification information of the user of the first game apparatus.

10. The game system according to claim 3, wherein
each of the first game apparatus and the second game apparatus is capable of connecting to a server apparatus via a network,
the game data updated by the second game control device is stored in the server apparatus in a state of being correlated with the identification information of the user, and
the reference data obtaining device is adapted and configured to obtain as the reference data at least one portion of the game data stored in the server apparatus in a state of being correlated with the identification information of the user of the first game apparatus.

11. The game system according to claim 8, wherein
each of the first game apparatus and the second game apparatus is capable of connecting to a server apparatus via a network,
the game data updated by the second game control device is stored in the server apparatus in a state of being correlated with the identification information of the user, and
the reference data obtaining device is adapted and configured to obtain as the reference data at least one portion of the game data stored in the server apparatus in a state of being correlated with the identification information of the user of the first game apparatus.

12. The game system according to claim 2, wherein
the first game control device is adapted and configured to calculate a result of the first game based on operations by the user in the first game; and
the reference effect control device is adapted and configured to change the result of the first game depending on the reference data obtained by the reference data obtaining device.

13. The game system according to claim 3, wherein
the first game control device is adapted and configured to calculate a result of the first game based on operations by the user in the first game; and
the reference effect control device is adapted and configured to change the result of the first game depending on the reference data obtained by the reference data obtaining device.

14. The game system according to claim 4, wherein
the first game control device is adapted and configured to calculate a result of the first game based on operations by the user in the first game; and
the reference effect control device is adapted and configured to change the result of the first game depending on the reference data obtained by the reference data obtaining device.

15. The game system according to claim 8, wherein
the first game control device is adapted and configured to calculate a result of the first game based on operations by the user in the first game; and
the reference effect control device is adapted and configured to change the result of the first game depending on the reference data obtained by the reference data obtaining device.

16. The game system according to claim 9, wherein
the first game control device is adapted and configured to calculate a result of the first game based on operations by the user in the first game; and
the reference effect control device is adapted and configured to change the result of the first game depending on the reference data obtained by the reference data obtaining device.

17. The game system according to claim 10, wherein
the first game control device is adapted and configured to calculate a result of the first game based on operations by the user in the first game; and
the reference effect control device is adapted and configured to change the result of the first game depending on the reference data obtained by the reference data obtaining device.

18. The game system according to claim 11, wherein
the first game control device is adapted and configured to calculate a result of the first game based on operations by the user in the first game; and
the reference effect control device is adapted and configured to change the result of the first game depending on the reference data obtained by the reference data obtaining device.
